(19) United States
(12) Patent Application Publication
(10) Pub. No.: US 2007/0243507 A1
(43) Pub. Date: Oct. 18, 2007

(54) Method for associative learning based upon the use of controlled release fragrances from substrates and product produced in accordance therewith

(76) Inventor: Denise Taylor, Glendale, NY (US)

Correspondence Address: Mitchell A. Stein;STEIN LAW, P.C., Suite 4, 24 Woodbine Avenue, Northport, NY, 11768, US

(21) Appl. No.: 11/404,140

(22) Filed: Apr. 14, 2006

(51) Int. Cl. G09B 19/00

(52) U.S. Cl. 434/236

(57) ABSTRACT

A method for creating associative learning based upon the use of controlled release fragrances from substrates, having visual cues that correlate with specific fragrances, creating substrates that contain said specific fragrances and release such fragrances over time; and applying the visual cues to the substrates. The visual cues include letters, words, phrases and/or images. Also included is the product produced thereby.

### FIELD OF THE INVENTION

The present invention relates to the field of fragrances embedded in a controlled-release matrix for airborne release, and more specifically to a method for a user to learn the correlation between certain fragrances and certain visual stimulation(s).

### BACKGROUND OF THE INVENTION

The instant invention relates to a system for providing fragrances that are airborne released from controlled release matrixes in a substrate that enables the individual to learn the correlation between certain fragrances and certain visual stimulation(s).

Odors, like fragrances, are detected by the nose and analyzed by the brain. Visual stimulation by the eyes and analysis by the brain involves visual cues including, for example, letters, words, phrases and images. Correlation between the two is a result of education. The instant invention derives from a method of education that creates fragrances that are then correlated with the visual cues in a teaching environment.

U.S. Pat. No. 6,962,496 to Houri shows a complicated apparatus arranged to present a user with various different scents and data, on a CD-ROM, in order to allow scent recognition. The apparatus as described in U.S. Pat. No. 6,962,496 furthermore allows the user to decide upon a combination of scent types desirable to the user. The apparatus as described in U.S. Pat. No. 6,962,496 however does not allow a mechanism whereby the user may associate different odoriferous objects with characteristic smells.

U.S. Pat. No. 5,918,882 to Truong shows a board game for testing a user's senses of sight, hearing, taste, smell, touch, and extrasensory perception. The apparatus as described in U.S. Pat. No. 5.918,882 however does not allow a mechanism whereby the user may associate different odoriferous objects with characteristic smells. U.S. Pat. No. 4,243,224 to Spector shows a scratch and smell puzzle having different odoriferous objects thereon.

In order to teach the correlation between letters, words, phrases and logos, on the one hand, and fragrances on the other, it is necessary that the teaching tool be created in a manner in which the correlation pre-exists the teaching. In other words, for “a” to be associated with “apple” it is necessary to release the odor of an apple in conjunction with the use of the letter “a” or an image of the apple.

Thus, it is an object of the invention to provide a teaching tool whereby letters, words, phrases and images, or other types of visual cues, are associated with an appropriate identifying fragrance such that upon smelling the fragrance, the visual cue can be identified.

Further objects will become apparent to one of ordinary skill in the art upon the understanding of the instant invention.

### SUMMARY OF THE INVENTION

The various features of novelty which characterize the present invention are expressly and unambiguously delineated in the claims annexed to and forming part of the disclosure. For a better understanding of the present invention, its practical advantages, and specific objects attained by its use, reference should be had to the drawings and descriptive matter in which there are illustrated and described preferred embodiments of the invention.

A method for creating associative learning based upon the use of controlled release fragrances from substrates, having visual cues that correlate with specific fragrances, creating substrates that contain said specific fragrances and release such fragrances over time; and applying the visual cues to the substrates. The visual cues include letters, words, phrases and/or images. Also included is the product produced thereby.

Unusual to the subject invention is the ability to have combined visual cues on a substrate that releases fragrances that correlate with those cues. For example, to teach someone about an apple, one may use a sticker of an apple applied to a substrate that smells like an apple and also contains the letters associated with “apple.” The substrates can include applications of flash cards, blocks, books, and other such items.

Other features will become apparent from reading the disclosure and claims of the instant invention.

### BRIEF DESCRIPTION OF THE DRAWINGS

In the drawings, wherein similar reference characters denote similar elements throughout the several views:

FIG. 1 is a flow chart of the method of the preferred embodiment of the subject invention showing the components and various functions thereof.

### DETAILED DESCRIPTION OF THE PREFERRED EMBODIMENTS

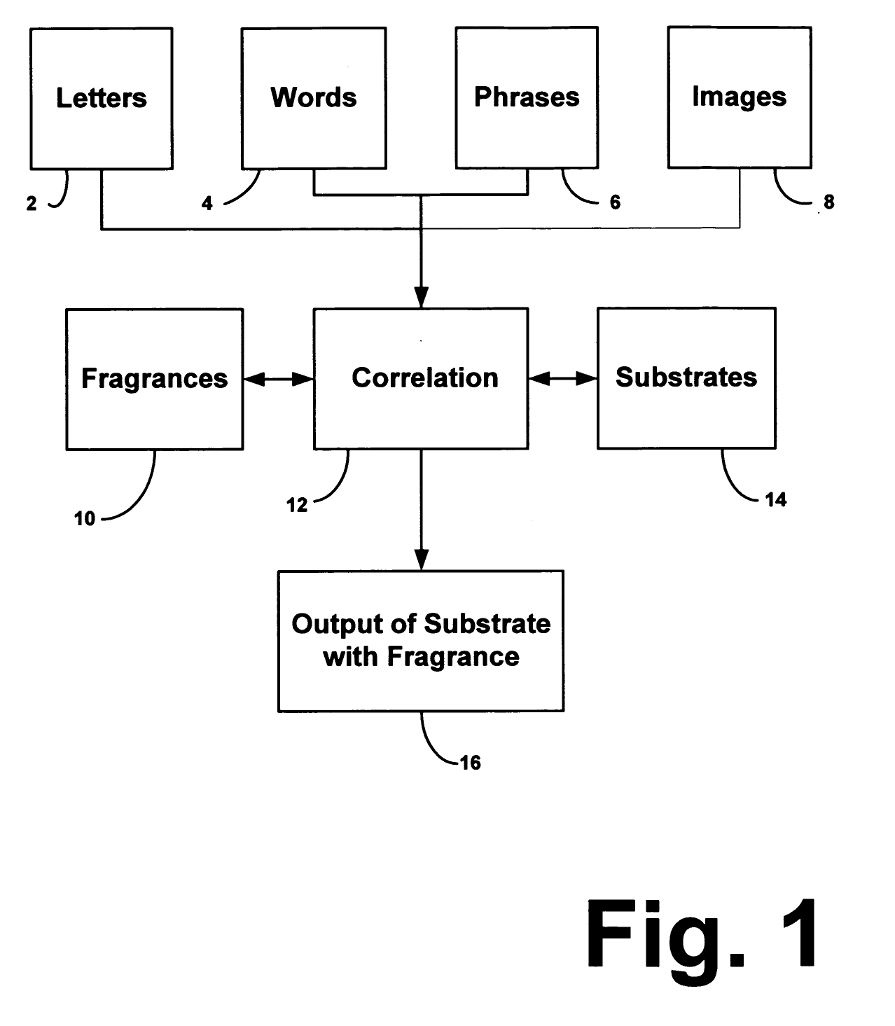

As shown in FIG. 1, letters 2, words 4, phrases 6 and images 8 are shown as visual cues, although other visual cues may be used without deviating from the letter or spirit of the teaching device herein. In particular, such visual cues are correlated via step 12 such that fragrances 10 are incorporated into substrates 14 with an output 16 such that the visual cues are identified specifically with the fragrance emitted.

It is thus a feature of the instant invention to provide visual cues that correlate with controlled release fragrances such that the visual cue will be understood when the fragrance is smelled.

While there have shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the invention, therefore, to be limited only as indicated by the scope of the claims appended hereto.

I claim:

1. A method for creating associative learning based upon the use of controlled release fragrances from substrates, comprising:
(a) correlating visual cues with specific fragrances;
(b) creating substrates that contain said specific fragrances and release the fragrance over time; and
(c) applying said visual cues to said substrates.

2. The method of claim 1, wherein the visual cues include letters, words, phrases and/or images.

3. The product produced in accordance with the method of claim 1.
